(19) United States
(12) Patent Application Publication
(10) Pub. No.: US 2024/0129988 A1
(43) Pub. Date: Apr. 18, 2024

(54) TECHNIQUES FOR IMPLICIT PATHLOSS REFERENCE SIGNALING IN TRANSMISSION CONFIGURATION INDICATORS

(71) Applicant: QUALCOMM Incorporated, San Diego, CA (US)

(72) Inventors: Fang YUAN, Beijing (CN); Yan ZHOU, San Diego, CA (US); Sony AKKARAKARAN, Poway, CA (US); Tao LUO, San Diego, CA (US)

(21) Appl. No.: 18/273,471

(22) PCT Filed: Feb. 3, 2021
(86) PCT No.: PCT/CN2021/074972

§ 371 Date: Jul. 20, 2023

(51) Int. Cl. H04W 76/20; H04B 7/06; H04L 5/00; H04W 52/14

(52) U.S. Cl. CPC H04W 76/20; H04B 7/0626; H04B 7/06968; H04L 5/0051; H04W 52/146

(57) ABSTRACT

Techniques for using implicit pathloss reference signal (RS) in a transmission configuration indication (TCI) may be performed. In an example, a method of wireless communication by a user equipment (UE), may include receiving, from a base station, a TCI state configuration. The method may also include determining a PLRS is not explicitly indicated by the TCI state configuration. The method may also include obtaining a default PLRS in response to the PLRS not being explicitly indicated by the TCI state configuration. The method may also include transmitting, to the base station, uplink (UL) power control information based on the default PLRS in a UL transmission.

### BACKGROUND

Aspects of the present disclosure relate generally to wireless communications, and more particularly, to techniques for implicit pathloss reference signal (PLRS) in transmission configuration indicator (TCI).

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

### SUMMARY

Systems, methods, and apparatus presented herein each have several innovative aspects, no single one of which is solely responsible for the desirable attributes disclosed herein. The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication by a user equipment (UE) is provided. The method may include receiving, from a base station, a transmission configuration information (TCI) state configuration for a uplink (UL) transmission. The method may include determining a pathloss reference signal (PLRS) is not explicitly indicated by the TCI state configuration. The method may include obtaining a default PLRS in response to the PLRS not being explicitly indicated by the TCI state configuration. The method may include transmitting, to the base station, the UL transmission with UL power control information based on the default PLRS.

In another aspect, a method of wireless communication by a base station is provided. The method may include transmitting, to a user equipment (UE), a transmission configuration information (TCI) state configuration. The method may include receiving, from the UE, uplink (UL) power control information corresponding to a default pathloss reference signal (PLRS). The method may include coordinating interferences between a plurality of UEs including the UE based on the UL power control information.

In other aspects, apparatuses and computer-readable mediums for performing these methods are provided.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network, according to aspects of the present disclosure;

FIG. 2 is a schematic diagram of an example of a user equipment (UE) of FIG. 1, according to aspects of the present disclosure;

FIG. 3 is a schematic diagram of an example of a base station of FIG. 1, according to aspects of the present disclosure;

FIG. 4 is a call flow diagram of example communications performed by a user equipment (UE) and base station of FIG. 1, according to aspects of the present disclosure;

FIG. 5 is flow diagram of an example method performed by the UE of FIG. 1, according to aspects of the present disclosure; and

FIG. 6 is flow diagram of an example method performed by a base station of FIG. 1, according to aspects of the present disclosure.

Additionally, an Appendix is attached and includes additional description and figures relating to the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Unified beam indication framework may include support for joint transmission configuration indicators (TCIs) for downlink (DL) and uplink (UL) transmissions. The term TCI may include a TCI state having at least one source reference signal (RS) to provide a reference assumed by a user equipment (UE) and used for determining quasi co-location (QCL) parameters and/or spatial filter parameters.

In an example, a source RF(s) in M TCIs, where M greater than or equal to 1, may provide common QCL information at least for UE-dedicated reception on physical DL share channels (PDSCHs) and all or a subset of core resource sets (CORESETs) in a control channel (CC). Optionally, common QCL information can also apply to channel state information (CSI)-RS (CSI-RS) resources for CSIs, CSI-RS resources for beam management (BM), and CSI-RSs for tracking. This may be applicable on PDSCHs including PDSCH default beams.

In an aspect, a source RS(s) in N TCIs, where N greater than or equal to 1, may provide a reference for determining common UL transmission (TX) spatial filter(s) at least for dynamic-grant or configured-grant based physical UL share channels (PUSCHs), all or subset of dedicated physical UL control channel (PUCCH) resources in a CC. Optionally, a UL TX spatial filter can also apply to all sounding RS (SRS) resources in resource set(s) configured for antenna switching/codebook-based/non-codebook-based UL transmissions. The UL TX spatial filter may be applicable to SRSs configured for beam management (BM). Further, PUSCH port determination may be based on the TCI (e.g., to be mapped with SRS ports).

In a unified TCI framework, to accommodate the case of separate beam indication for UL and DL, two separate TCI states may be utilized: one for DL and one for UL. For frequency range 1 (FR1), a UE may not expect a UL TCI to provide a reference for determining common UL TX spatial filter(s), if the UL TCI is supported for FR1. For a separate DL TCI, a source RS(s) in M TCIs may provide QCL information at least for UE-dedicated reception on a PDSCH and for UE-dedicated reception on all or a subset of CORESETs in a CC. For a separate UL TCI, a source RF(s) in N TCIs may provide a reference for determining common UL TX spatial filter(s) at least for dynamic-grant/configured-grant based PUSCHs and/or all or a subset of dedicated PUCCH resources in a CC. Optionally, a UL TX spatial filter can also apply to all SRS resources in resource set(s) configured for antenna switching/codebook-based/non-codebook-based UL transmissions.

In an aspect, pathloss RS (PLRS) indications may not be explicitly indicated in a TCI. For unified TCI framework, a pool of joint DL/UL TCI states may be used for joint DL/UL TCI state update (e.g., for beam indication). Also, a pool for separate DL and UL TCI state updates (e.g., for beam indication) may be used. The TCI state pool may refer to a pool configured via higher-layer (RRC) signaling. Whether a joint TCI may include UL specific parameter(s) such as UL power control and/or timing parameters, PLRS, panel-related indication, etc. and if it is included, it may be used only for UL transmissions of the DL and UL transmissions to which the joint TCI is applied.

Aspects of the present disclosure describe techniques for indicating a PLRS for a UL transmission of a SRS, a PUCCH, or a PUSCH. In an example, a PLRS may be explicitly included in a UL TCI state or a joint TCI state for a SRS, a PUCCH, or a PUSCH. When a PLRS is not explicitly associated with or included in the UL or joint TCI state, a default PLRS may be applied to a SRS, a PUCCH, or a PUSCH. For example, a periodic DL RS associated with a source RS for determining a spatial transmission filter in a UL or joint TCI state, may be the PLRS. In this example, a UE may calculate path-loss based on a periodic DL RS from a QCL information source or a spatial relation information source of the RS in the UL TCI state or the joint TCI state. In another example, a PLRS may be associated with (but not included in) a UL TCI state or a joint TCI state. In this example, a medium access control—control element (MAC-CE) and/or DL control indicator (DCI) may be used to indicate a PLRS for UL transmission.

For an SRS, a PUSCH, or a PUCCH with an indicated UL or a joint DL/UL TCI state, if a PLRS is not explicitly included with the TCI state, the PLRS may be implied based on one of the following options.

In a first option, a QCL-TypeD RS or a spatial relation information RS in the TCI state may provide the PLRS for the SRS, the PUSCH, or the PUCCH. For example, a UE may determine a RS resource index q_d that provides a periodic RS resource with QCL-TypeD or spatial relation information in the unified TCI state as the PLRS. In another example, the UE may determine a RS resource index q_d to include a periodic CSI-RS resource index quasi co-located (QCLed) with the RS indexes in the RS sets indicated by a TCI state and, if there are two RS indexes in the TCI state, the RS index with QCL-TypeD information or spatial relation information for the corresponding TCI state.

In a second option, a QCL-TypeD RS of a CORESET having a predetermined identification (e.g., lowest or highest identification) may provide the PLRS for an SRS, a PUSCH, or a PUCCH. In an example, a UE may determine a RS resource index q_d providing a periodic RS resource with QCL-TypeD in the QCL assumption of a CORESET with the predetermined index in an active DL BWP of a serving cell.

In a third option, the QCL-TypeD RS or the spatial relation information of the TCI of a predetermined identification (e.g., lowest or highest identification) activated by the MAC-CE may provide the PLRS for the SRS, the PUSCH, or the PUCCH. For example, the UE may determine an RS resource index q_d providing a periodic RS resource with QCL-TypeD or spatial relation information in the active unified TCI state with the predetermined identification in the active DL BWP. In another example, the UE may determine an RS resource index q_d to include a periodic CSI-RS resource index QCLed with the RS indexes in the RS sets indicated by TCI-State and, if there are two RS indexes in a TCI state, the RS index with QCL-TypeD spatial relation information for the corresponding TCI state.

Some conditions may be applied for using implicit PLRS (or default PLRS). In an aspect, a UE may only support up to a predetermined number (e.g., four) of PLRSs, but TCI states may support a greater number of PLRSs. In an example, a default PLRS may be applied when one or more of the following characteristics are determined: (a) a total number of active or configured TCIs is greater than or equal to X, where X equals the predetermined number (e.g., four). In this example, a maximum number of PLRS may be equal to the predetermined number; (b) a total number of periodic QCL-typeD RSs in active or configured TCIs is greater than or equal to X; (c) a total number of periodic RSs serving as a QCL-type D source for a QCL-typeD RS in active or configured TCIs is greater than or equal to X; (d) the base station (e.g., gNB) indicates an application via an enablement flag; or (e) at least one PLRS associated with a TCI is explicitly configured or included, for example, the PLRS is directly configured in the TCI or the PLRS is configured outside and linked to the TCI.

In another aspect, for a joint DL/UL TCI update applicable to a PUSCH, if a PLRS is not indicated with a TCI state, a UE can prioritize the PLRS based on any predetermined order of the following cases: (1) a PLRS associated with an SRS set of “codebook” or “noncodebook;” (2) a PLRS associated with a PUCCH of a predetermined identification (e.g., lowest or highest identification); (3) a PLRS associated with a QCL assumption of a CORESET with a predetermined index (e.g., lowest or highest index); (4) a PLRS associated with an active unified TCI state with a predetermined identification (e.g., lowest or highest identification); or (5) a PLRS associated with an indicated unified TCI state. In this example, a highest priority order may be Case 1 through Case 5. However, implementations of the present disclosure are not limited to this specific order.

In another aspect, for a joint DL/UL TCI update applicable to an SRS, if a PLRS is not indicated with a TCI state, a UE can prioritize the PLRS based on any predetermined order to the following cases: (1) a PLRS associated with a QCL assumption of a CORESET with a predetermined index (e.g., the lowest or highest index); (2) a PLRS associated with an active unified TCI state with a predetermined identification (e.g., lowest or highest identification); or a PLRS associated with an indicated unified TCI state. In an example, a higher priority order can be Case 1 through Case 3. However, implementations of the present disclosure are not limited to this specific order.

In another aspect, for a joint DL/UL TCI update applicable to a PUCCH, if a PLRS is not indicated with a TCI state, a UE can prioritize the PLRS based on any predetermined order to the following cases: (1) a PLRS associated with a QCL assumption of a CORESET with a predetermined index (e.g., lowest or highest index); (2) a PLRS associated with an active unified TCI state with a predetermined identification (e.g., lowest or highest identification); or (3) a PLRS associated with an indicated unified TCI state. In an example, a higher priority order can be Case 1 through Case 3. However, implementations of the present disclosure are not limited to this specific order.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Turning now to the figures, examples of systems, apparatus, and methods according to aspects of the present disclosure are depicted. It is to be understood that aspects of the figures may not be drawn to scale and are instead drawn for illustrative purposes.

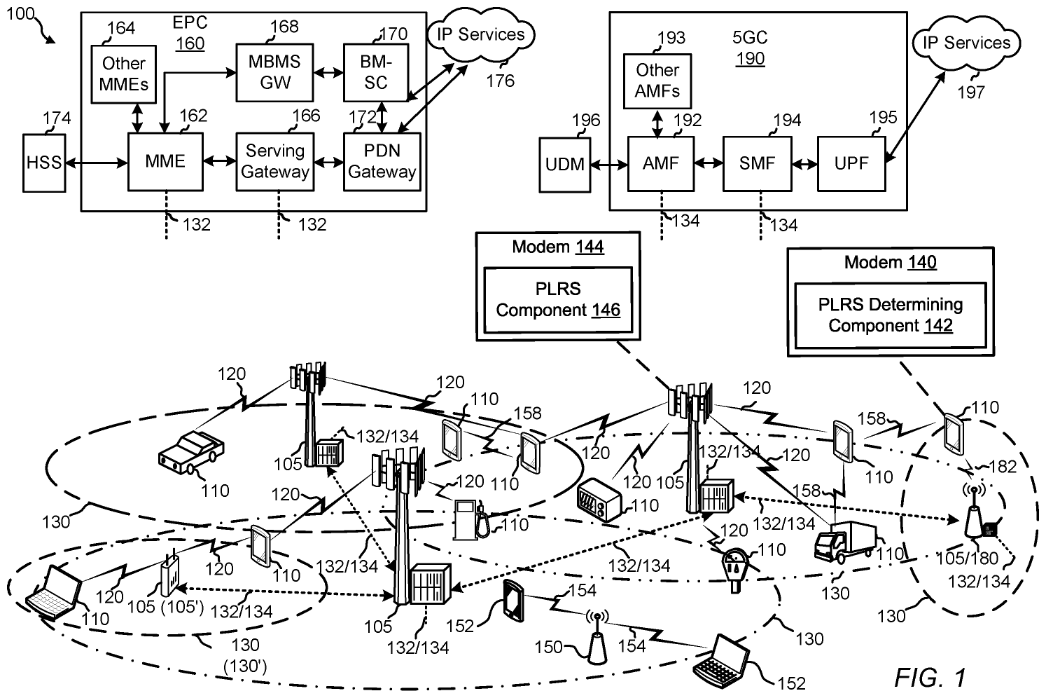

FIG. 1 is a diagram illustrating an example of a wireless communications system and an access network 100. The wireless communications system (also referred to as a wireless wide area network (WWAN)) includes at least one base station 105, UEs 110, an Evolved Packet Core (EPC) 160, and a 5G Core (5GC) 190. The base station 105 may include macro cells (high power cellular base station) and/or small cells (low power cellular base station). The macro cells include base stations. The small cells include femtocells, picocells, and microcells.

In some implementations, UEs 110 may include a modem 140 and/or a PLRS determining component 142 for determining a PLRS to be used for measurements of UL transmission power control. In some implementations, the base station 105 may include a modem 144 and/or a PLRS component 146 for configuring TCI states for the UE 110 and coordinating interference between UEs 110.

A base station 105 may be configured for 4G LTE (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A base station 105 configured for 5GNR (collectively referred to as Next Generation RAN (NG-RAN)) may interface with 5GC 190 through backhaul links interfaces 134 (e.g., S1, X2, Internet Protocol (IP), or flex interface). In addition to other functions, the base station 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base station 105 may communicate directly or indirectly (e.g., through the EPC 160 or 5GC 190) with each other over the backhaul links interfaces 134. The backhaul links 132, 134 may be wired or wireless.

The base station 105 may wirelessly communicate with the UEs 110. Each of the base station 105 may provide communication coverage for a respective geographic coverage area 130. There may be overlapping geographic coverage areas 130. For example, the small cell 105′ may have a coverage area 130′ that overlaps the coverage area 130 of one or more macro base station 105. A network that includes both small cell and macro cells may be known as a heterogeneous network. A heterogeneous network may also include Home Evolved Node base station (eNBs) (HeNBs), which may provide service to a restricted group known as a closed subscriber group (CSG). The communication links 120 between the base station 105 and the UEs 110 may include uplink (UL) (also referred to as reverse link) transmissions from a UE 110 to a base station 105 and/or downlink (DL) (also referred to as forward link) transmissions from a base station 105 to a UE 110. The communication links 120 may use multiple-input and multiple-output (MIMO) antenna technology, including spatial multiplexing, beamforming, and/or transmit diversity. The communication links may be through one or more carriers. The base station 105/UEs 110 may use spectrum up to Y MHz (e.g., 5, 10, 15, 20, 100, 400, etc. MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A base station 105, whether a small cell 105′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 110. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base station 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The base station 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

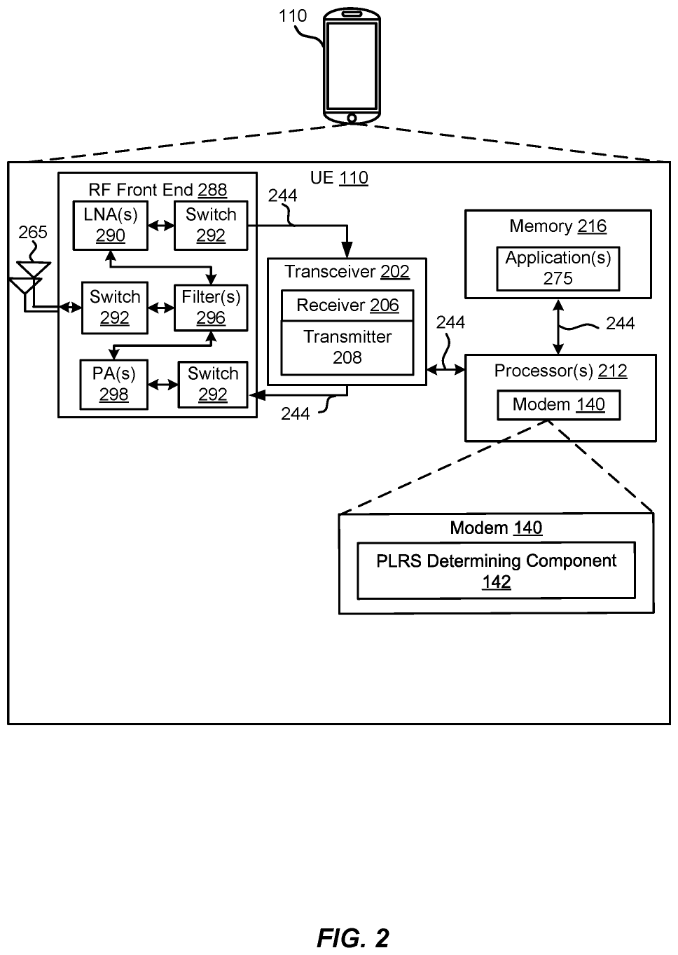

Referring to FIG. 2, an example implementation of the UE 110 may include the modem 140 having the PLRS determining component 142. The modem 140 and/or the PLRS determining component 142 of the UE 110 may be configured to receive, from the base station 105, a TCI state configuration, determine a PLRS for a UL transmission is not explicitly indicated by the TCI state configuration, obtain a default PLRS in response to the PLRS not being explicitly indicated by the TCI state configuration, and transmit, to the base station, the UL power control information based on the default PLRS in the UL transmission.

In some implementations, the UE 110 may include a variety of components, including components such as one or more processors 212 and memory 216 and transceiver 202 in communication via one or more buses 244, which may operate in conjunction with the modem 140 and/or the PLRS determining component 142 to enable one or more of the functions related to determining pathloss. Further, the one or more processors 212, modem 140, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 140 that uses one or more modem processors. The various functions related to the PLRS determining component 142 may be included in the modem 140 and/or the processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 140 may configure the UE 110 along with the processors 212. In other aspects, some of the features of the one or more processors 212 and/or the modem 140 associated with the PLRS determining component 142 may be performed by the transceiver 202.

Also, the memory 216 may be configured to store data used herein and/or local versions of applications 275 or the PLRS determining component 142 and/or one or more subcomponents of the PLRS determining component 142 being executed by at least one processor 212. The memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, the memory 216 may be a non-transitory computer-readable storage medium that stores one or more computer-executable codes defining the PLRS determining component 142 and/or one or more of its subcomponents, and/or data associated therewith, when the UE 110 is operating at least one processor 212 to execute the PLRS determining component 142 and/or one or more of the subcomponents.

The transceiver 202 may include at least one receiver 206 and at least one transmitter 208. The receiver 206 may include hardware, firmware, and/or software code executable by a processor for receiving data, the code comprising instructions and being stored in a memory (e.g., computer-readable medium). The receiver 206 may be, for example, an RF receiving device. In an aspect, the receiver 206 may receive signals transmitted by at least one base station 105. The transmitter 208 may include hardware, firmware, and/or software code executable by a processor for transmitting data, the code comprising instructions and being stored in a memory (e.g., computer-readable medium). A suitable example of the transmitter 208 may include, but is not limited to, an RF transmitter.

Moreover, in an aspect, the UE 110 may include the RF front end 288, which may operate in communication with one or more antennas 265 and the transceiver 202 for receiving and transmitting radio transmissions, for example, wireless communications transmitted by at least one base station 105 or wireless transmissions transmitted by the UE 110. The RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, the LNA 290 may amplify a received signal at a desired output level.

In an aspect, each of the LNAs 290 may have a specified minimum and maximum gain values. In an aspect, the RF front end 288 may use one or more switches 292 to select a particular LNA 290 and the specified gain value based on a desired gain value for a particular application.

Further, for example, one or more PA(s) 298 may be used by the RF front end 288 to amplify a signal for an RF output at a desired output power level. In an aspect, each of the PAs 298 may have specified minimum and maximum gain values. In an aspect, the RF front end 288 may use one or more switches 292 to select a particular PA 298 and the specified gain value based on a desired gain value for a particular application.

Also, for example, one or more filters 296 may be used by the RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, the RF front end 288 may use one or more switches 292 to select a transmit or receive path using a specified filter 296, the LNA 290, and/or the PA 298, based on a configuration as specified by the transceiver 202 and/or processor 212.

As such, the transceiver 202 may be configured to transmit and receive wireless signals through one or more antennas 265 via the RF front end 288. In an aspect, the transceiver 202 may be tuned to operate at specified frequencies such that the UE 110 may communicate with, for example, one or more of the base stations 105 or one or more cells associated with one or more of the base stations 105. In an aspect, for example, the modem 140 may configure the transceiver 202 to operate at a specified frequency and power level based on a UE configuration of the UE 110 and the communication protocol used by the modem 140.

In an aspect, the modem 140 may be a multiband-multimode modem, which may process digital data and communicate with the transceiver 202 such that the digital data is sent and received using the transceiver 202. In an aspect, the modem 140 may be multiband and be configured to support multiple frequency bands for a specific communications protocol. In an aspect, the modem 140 may be multimode and be configured to support multiple operating networks and communications protocols. In an aspect, the modem 140 may control one or more components of the UE 110 (e.g., RF front end 288, transceiver 202) to enable transmission and/or reception of signals from the network based on a specified modem configuration. In an aspect, a modem configuration may be based on the mode of the modem 140 and the frequency band in use. In another aspect, the modem configuration may be based on UE configuration information associated with the UE 110 as provided by the network (e.g., base station 105).

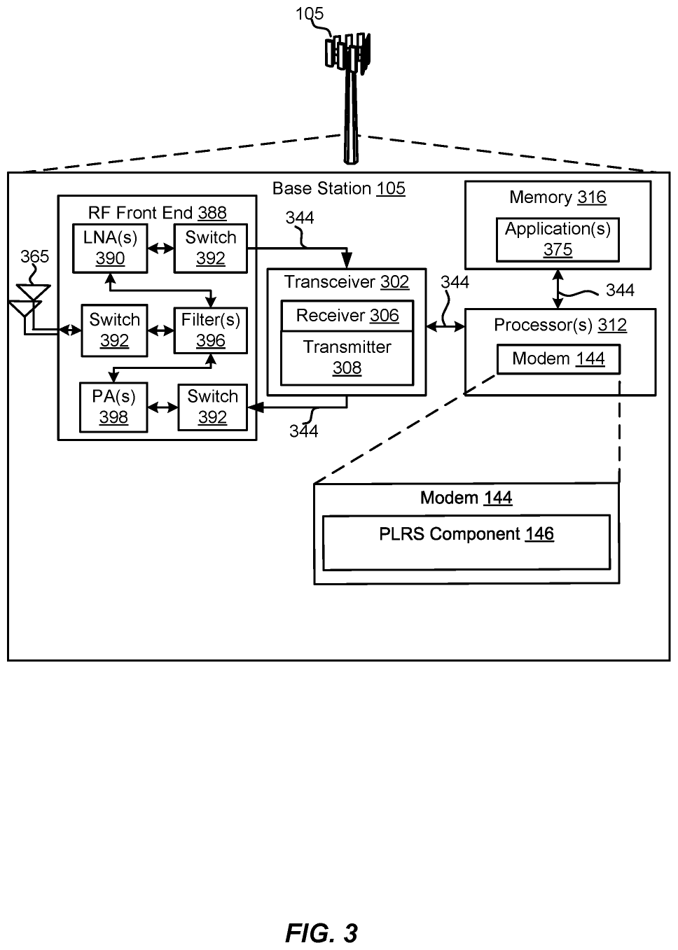

Referring to FIG. 3, an example implementation of the base station 105 may include the modem 144 with the PLRS component 146 configured to coordinate interference between UEs 110 based on pathloss information from the UE 110. The modem 144 and/or the PLRS component 146 of the base station 105 may be configured to communicate with the UE 110 via a cellular network, a Wi-Fi network, or other wireless and wired networks.

In some implementations, the base station 105 may include a variety of components, including components such as one or more processors 312 and memory 316 and transceiver 302 in communication via one or more buses 344, which may operate in conjunction with the modem 144 and the PLRS component 146 to enable one or more of the functions related to pathloss described herein. Further, the one or more processors 312, the modem 144, the memory 316, the transceiver 302, a RF front end 388, and one or more antennas 365, may be configured to support voice and/or data calls (simultaneously or non-simultaneously) in one or more radio access technologies. The one or more antennas 365 may include one or more antennas, antenna elements and/or antenna arrays.

In an aspect, the one or more processors 312 may include the modem 144 that uses one or more modem processors. The various functions related to the PLRS component 146 may be included in the modem 144 and/or the processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with the transceiver 302. Additionally, the modem 144 may configure the base station 105 and the processors 312. In other aspects, some of the features of the one or more processors 312 and/or the modem 144 associated with the PLRS component 146 may be performed by the transceiver 302.

Also, the memory 316 may be configured to store data used herein and/or local versions of applications 375 or the PLRS component 146, and/or one or more subcomponents of the PLRS component 146 being executed by at least one processor 312. The memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, the memory 316 may be a non-transitory computer-readable storage medium that stores one or more computer-executable codes defining the PLRS component 146 and/or one or more of the subcomponents, and/or data associated therewith, when the base station 105 is operating at least one processor 312 to execute the PLRS component 146 and/or one or more of the subcomponents.

The transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, an RF receiving device. In an aspect, the receiver 306 may receive signals transmitted by the UE 110. The transmitter 308 may include hardware, firmware, and/or software code executable by a processor for transmitting data, the code comprising instructions and being stored in a memory (e.g., computer-readable medium). A suitable example of the transmitter 308 may include, but is not limited to, an RF transmitter.

Moreover, in an aspect, the base station 105 may include the RF front end 388, which may operate in communication with one or more antennas 365 and the transceiver 302 for receiving and transmitting radio transmissions, for example, wireless communications transmitted by other base stations 105 or wireless transmissions transmitted by the UE 110. The RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, the LNA 390 may amplify a received signal at a desired output level.

In an aspect, each of the LNAs 390 may have a specified minimum and maximum gain values. In an aspect, the RF front end 388 may use one or more switches 392 to select a particular LNA 390 and the specified gain value based on a desired gain value for a particular application.

Further, for example, one or more PA(s) 398 may be used by the RF front end 388 to amplify a signal for an RF output at a desired output power level. In an aspect, each PA 398 may have specified minimum and maximum gain values. In an aspect, the RF front end 388 may use one or more switches 392 to select a particular PA 398 and the specified gain value based on a desired gain value for a particular application.

Also, for example, one or more filters 396 may be used by the RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, the RF front end 388 may use one or more switches 392 to select a transmit or receive path using a specified filter 396, the LNA 390, and/or the PA 398, based on a configuration as specified by the transceiver 302 and/or the processor 312.

As such, the transceiver 302 may be configured to transmit and receive wireless signals through one or more antennas 365 via the RF front end 388. In an aspect, transceiver may be tuned to operate at specified frequencies such that the base station 105 may communicate with, for example, the UE 110 or one or more cells associated with one or more base station 105. In an aspect, for example, the modem 144 may configure the transceiver 302 to operate at a specified frequency and power level based on the base station configuration of the base station 105 and the communication protocol used by the modem 144.

In an aspect, the modem 144 may be a multiband-multimode modem, which may process digital data and communicate with the transceiver 302 such that the digital data is sent and received using the transceiver 302. In an aspect, the modem 144 may be multiband and be configured to support multiple frequency bands for a specific communications protocol. In an aspect, the modem 144 may be multimode and be configured to support multiple operating networks and communications protocols. In an aspect, the modem 144 may control one or more components of the base station 105 (e.g., RF front end 388, transceiver 302) to enable transmission and/or reception of signals from the network based on a specified modem configuration. In an aspect, the modem configuration may be based on the mode of the modem 144 and the frequency band in use. In another aspect, the modem configuration may be based on a base station configuration associated with the base station 105.

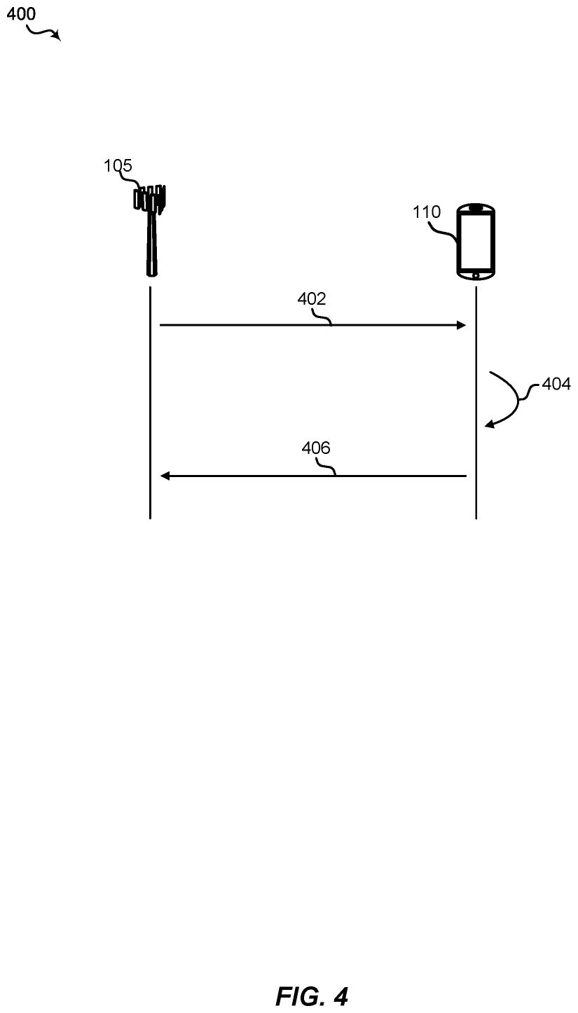

Referring to FIG. 4, a conceptual example of a call flow diagram 400 illustrating communications between the base station 105 and the UE 110 for pathloss configurations is described. In an aspect, the base station 105 may, at operation 402, transmit TCI configurations to the UE 110. The TCI configurations may include a plurality of RSs including a quasi co-located (QCL)-type A RS, a QCL-type D RS or a spatial relation information RS, and/or a PLRS. When the PLRS is explicitly indicated by the TCI configuration, the UE 110, at operation 404, may determine pathloss based on the PLRS. For example, the UE 110 may determine the pathloss based on a difference between a transmit power of the PLRS and one or more measurements (e.g., reference signal receive power (RSRP) measurement). In response to the determined pathloss, the UE 110, at operation 406, may transmit a UL with information on the pathloss and/or power control to the base station 105. The base station 105 may use the information to determine interferences between the UE 110 and other UEs 110.

In some examples, the base station 105 may not explicitly indicate the pathloss in the operation 402. In this case, the UE 110 implicitly determines the PLRS to use. In other words, the UE 110 determines a default PLRS to be used when the base station 110 does not explicitly indicate the PLRS. Aspects of the present disclosure describe different techniques for determining the default PLRS.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

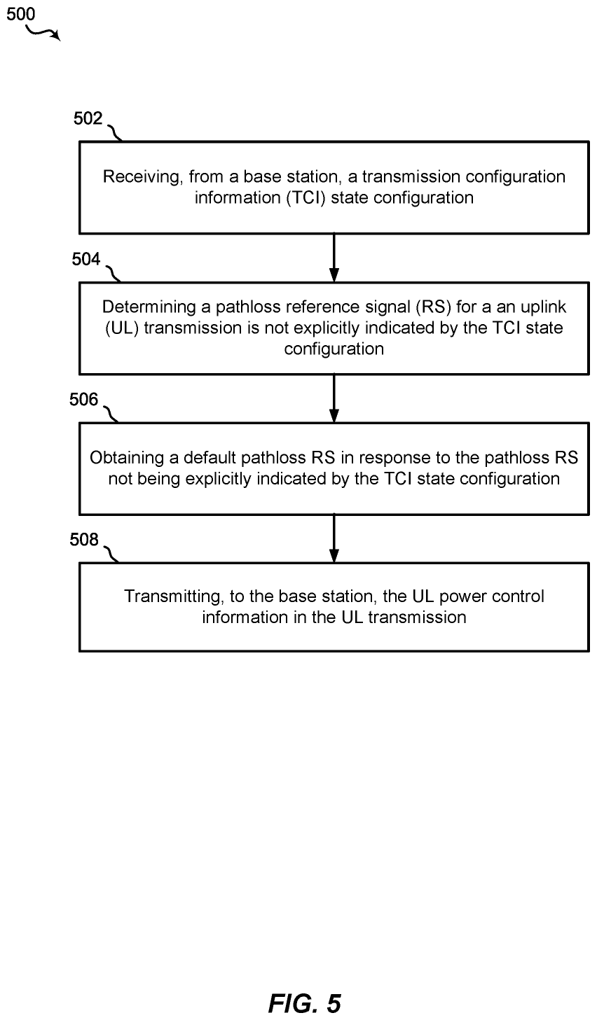

Referring to FIG. 5, an example of a method 500 for determining the default PLRS may be performed by the PLRS determining component 142, the modem 140, the transceiver 202, the processor 212, the memory 216, and or any other component/subcomponent of the UE 110 of the wireless communication network 100.

At block 502, the method 500 may include receiving, from a base station, a TCI state configuration for a UL transmission. For example, the PLRS determining component 142, the modem 140, the transceiver 202, the processor 212, and/or the memory 216 of the UE 110, and/or one or more additional components/subcomponents of the UE 110 may be configured to or may comprise means for receiving, from a base station, TCI state configuration for a UL transmission.

For example, the receiving by the UE 110 at the block 502 may include receiving by the PLRS determining component 142, the modem 140, the processor 212, the transceiver 202, and/or the memory 216 of the UE 110, from the base station 105, TCI state configuration for a UL transmission as shown by operation 402 of FIG. 4.

In some examples, the TCI state may refer to a unified TCI state, which may be any of the following: 1) Uplink(UL) TCI: The source reference signal in a UL TCI provides a reference for determining UL spatial transmit filter for at least one of PUSCH transmissions, PUCCH transmissions and SRS transmissions in a serving cell. 2) Joint DL/UL TCI or Joint TCI: A TCI refers to at least a common source reference signal used for determining both the downlink QCL information and the uplink spatial transmit filter. The source reference signal in a TCI provides QCL information for at least one of PDSCH receptions, CSI-RS receptions, and CORESETs in a serving cell, and provides a reference for determining UL spatial transmit filter for at least one of PUSCH transmissions, PUCCH transmissions and SRS transmissions in a serving cell.

In some aspects, the TCI state configuration may be indicated by any of radio resource control (RRC) signaling, MAC-CE signaling, and DL control information (DCI) signaling. The signaling for TCI state configuration may be the same or different to the signaling scheduling a ULtransmission which is applicable to the indicated TCI state. For example, the base station 105 may indicate to the UE 110 by a first signaling (e.g., MAC-CE signaling or DCI signaling) which includes a TCI state and by a second signaling (e.g., DCI signaling) which schedules a UL transmission of PUSCH, PUCCH or SRS transmission, and the UE 110 may apply the TCI state indicated in the first signaling to the UL transmission scheduled in the second signaling.

In some examples of explicit indicating a PLRS with a TCI state, a PLRS may be explicitly included in a TCI state. That is, a TCI state may provide an explicit RS (such as periodical CSI-RS) as the PLRS. In some other examples of explicit indicating a PLRS with a TCI state, a PLRS may be not included but associated with a TCI state by an association signaling. The signaling to associate a PLRS with a TCI state may be any of RRC signaling, MAC-CE signaling, and DCI signaling, and may be jointly or separately signaled with the signaling for the TCI configuration. In an example, the TCI state configuration may include a QCL-type D RS, a transmit spatial filter RS, or a spatial relation information RS.

At block 504, the method 500 may include determining a PLRS is not explicitly indicated by the TCI state configuration. For example, the PLRS determining component 142, the modem 140, the transceiver 202, the processor 212, and/or the memory 216 of the UE 110, and/or one or more additional components/subcomponents of the UE 110 may be configured to or may comprise means for determining a PLRS is not explicitly indicated by the TCI state configuration.

For example, the determining the PLRS is not explicitly indicated by the TCI state configuration at block 504 may include determining by the PLRS determining component 142, the modem 140, the processor 212, the transceiver 202, and/or the memory 216 of the UE 110 the PLRS is not explicitly indicated in the TCI state configuration transmitted by the base station 105 of operation 402 of FIG. 4 in response to information indicated by the TCI state configuration not including an explicit PLRS. In an example, the UE 110 may determine that the PLRS is neither explicitly included in nor associated with the TCI state configuration.

At block 506, the method 500 may include obtaining a default PLRS in response to the PLRS not being explicitly indicated by the TCI state configuration. For example, the PLRS determining component 142, the modem 140, the processor 212, and/or the memory 216 of the UE 110, and/or one or more additional components/subcomponents of the UE 110 may be configured to or may comprise means for obtaining a default PLRS in response to the PLRS not being explicitly indicated by the TCI state configuration. In an example, the UE 110 may apply the default PLRS for a UL transmission applicable with the indicated TCI state configuration.

For example, the obtaining the default PLRS may include obtaining by the PLRS determining component 142, the modem 140, the processor 212, and/or the memory 216 of the UE 110 the default PLRS in response to the PLRS not being explicitly indicated by the TCI state configuration as illustrated by operation 404 of FIG. 4.

In an aspect, the PLRS determining component 142, the modem 140, the processor 212, and/or the memory 216 of the UE 110 may obtain the default PLRS for a UL transmission based on the TCI state in the TCI state configuration indicated to the UL transmission.

In an aspect, the PLRS determining component 142, the modem 140, the processor 212, and/or the memory 216 of the UE 110 may obtain the default PLRS by setting a periodic DL RS associated with a source RS as the default PLRS. In some examples, if the PLRS is not explicitly indicated by the TCI state configuration, the UE 110 may determine the default PLRS is the periodic DL RS used as a source RS for determining a spatial transmit filter or the PL-RS used for the UL RS in a UL TCI state or a joint TCI state. For example, if the UL TCI state or joint TCI state in the TCI indication includes a periodic DL RS used as a source RS for determining a spatial transmit filter, the UE 110 may determine to use a periodic DL RS as the default PLRS. In some other examples, if the UL TCI or the joint TCI state in the TCI indication includes a UL RS used as a source RS for determining the spatial transmit filter, the UE 110 may determine to use the PLRS used for transmission of the UL RS as the default PLRS.

In an aspect, the PLRS determining component 142, the modem 140, the processor 212, and/or the memory 216 of the UE 110 may obtain the default PLRS by setting a periodic CSI-RS associated with a source RS as the default PLRS. In some example, the UE 110 may determine the default PLRS by using an RS resource index providing a DL periodic RS resource with QCL-TypeD, spatial transmit filter or spatial relation information in the TCI state configuration. For example, if the UL TCI state or the joint TCI state in the TCI indication includes a non-periodic DL RS or a UL RS used as a source RS for determining spatial transmit filter, the UE 110 may determine a periodic CSI-RS which is associated with the source RS in the TCI state as the default PLRS. In some other examples, the determined periodic CSI-RS as the default PLRS may be a periodic CSI-RS which provides QCL information or spatial transmit filter to the source RS in the TCI state.

In an aspect, the PLRS determining component 142, the modem 140, the processor 212, and/or the memory 216 of the UE 110 may obtain the default PLRS by other signaling than the TCI state configuration. In some example, the UE 110 may determine the default PLRS based on a dedicated PLRS signalling. The dedicated PLRS signalling may be any of a RRC signalling, a MAC-CE signalling or a DCI signalling which indicates a PLRS not associated with any TCI state configuration for a uplink transmission. For example, the SRI field in DCI signaling may indicate a PLRS for the PUSCH transmission scheduled by the same DCI. In another example, a MAC-CE signaling may indicate a PLRS for a SRS transmission.

In an aspect, the PLRS determining component 142, the modem 140, the processor 212, and/or the memory 216 of the UE 110 may obtain the default PLRS by setting a QCL RS or spatial relation information RS of the TCI state configuration as the default PLRS. In an example, the PLRS determining component 142, the modem 140, the processor 212, and/or the memory 216 of the UE 110 may select an RS resource index (e.g., q_{d}) having a periodic RS with QCL information (e.g., QCL type D), spatial transmit filter, or spatial relation information in the TCI state configuration, and set an RS associated with the RS resource index as the default PLRS. In another example, the PLRS determining component 142, the modem 140, the processor 212, and/or the memory 216 of the UE 110 may select an RS resource index (e.g., q_{d}) having a periodic CSI-RS resource index that is quasi co-located with the RS resource index, and set the periodic CSI-RS associated with the RS resource index as the default PLRS. In this example, if there are two RS resource indexes in a TCI state, the periodic CSI-RS associated with the RS resource index with a QCL type D RS, spatial transmit filter, or spatial relation information RS is used as the default PLRS.

In an aspect, the PLRS determining component 142, the modem 140, the processor 212, and/or the memory 216 of the UE 110 may obtain the default PLRS for a UL transmission based on a TCI state in the TCI state configuration indicated to other channels or signals.

In an aspect, the PLRS determining component 142, the modem 140, the processor 212, and/or the memory 216 of the UE 110 may obtain the default PLRS by setting a QCL RS of a control resource set (CORESET) as the default PLRS. For example, the PLRS determining component 142, the modem 140, the processor 212, and/or the memory 216 of the UE 110 may select an RS resource index (e.g., q_{d}) having a periodic RS resource with QCL information (e.g., QCL type D) having CORESET with a predetermined index (e.g., lowest index), and set an RS associated with the RS resource index as the default PLRS. In an example, the CORESET with the predetermined index may be in an active DL bandwidth part (BWP) of a servicing cell. In some example, the UE 110 may determine the default PLRS as a RS resource index (e.g., q_{d}) providing a periodic RS resource with QCL-TypeD in the QCL assumption or the TCI state of a CORESET with the lowest index in the active DL BWP of serving cell.

In an aspect, the PLRS determining component 142, the modem 140, the processor 212, and/or the memory 216 of the UE 110 may obtain the default PLRS by setting a QCL RS or spatial relation information RS of an active TCI state of the TCI state configuration as the default PLRS. For example, the PLRS determining component 142, the modem 140, the processor 212, and/or the memory 216 of the UE 110 may select an RS resource index (e.g., q_{d}) having a periodic RS with QCL information or spatial relation information in the active TCI state, and set an RS associated with the RS resource index as the default PLRS. In another example, the PLRS determining component 142, the modem 140, the processor 212, and/or the memory 216 of the UE 110 may select an RS resource index (e.g., q_{d}) associated with the active TCI state and having a periodic CSI-RS index that is quasi co-located with the RS resource index, and set an RS associated with the RS resource index as the default PLRS. In this example, if there are two RS resource indexes in a TCI state, the RS resource index with a QCL type D RS or spatial relation information RS is used as the default PLRS. For example, the UE110 may determine the default PLRS as a RS resource index (e.g., q_{d}) providing a periodic RS resource with QCL-TypeD, spatial transmit filter, or spatial relation information in the active TCI state with lowest ID in the active DL BWP of serving cell. For some other examples, the UE 110 may determine the default PLRS as a RS resource index (e.g., q_{d}) providing a periodic RS resource with QCL-TypeD, spatial transmit filter, or spatial relation information in the active TCI state that is mapped into one (e.g., the lowest) codepoint of the DCI's TCI field in the active DL BWP of serving cell.

In an aspect, the PLRS determining component 142, the modem 140, the processor 212, and/or the memory 216 of the UE 110 may obtain the default PLRS for a UL transmission with the TCI configuration not explicitly indicating a PLRS when one or more of the following parameters are met: 1) a total number of active TCI states is less than or equal to a predetermined number; 2) a total number of periodic RSs which are as source RSs in the active TCI states is less than or equal to a predetermined number; 3) a total number of periodic RSs serving as a QCL type D RS, spatial transmit filter RS, or spatial relation information RS for source RSs in the active TCI states is less than or equal to a predetermined number; 4) the base station indicates an application of the default PLRS via an enablement flag; 5) at least one PLRS of a plurality of PLRSs is explicitly included or associated with a TCI state; or 6) at least one configured or activated TCI state is explicitly included or associated with a PLRS, where the active TCI states may be activated by a MAC-CE signaling, the predetermined number may be the maximum number of PLRSs (such as four), and the type of periodic reference signals may include any of CSI-RS, SSB or SRS.

In an aspect, the PLRS determining component 142, the modem 140, the processor 212, and/or the memory 216 of the UE 110 may obtain the default PLRS based on a prioritization of the PLRS used as the default PLRS. For example, for joint DL/UL TCI configurations or UL TCI configuration applicable to a PUSCH transmission, the PLRS determining component 142, the modem 140, the processor 212, and/or the memory 216 of the UE 110 may determine the PLRS for the PUSCH transmission as one from the following: 1) the PLRS determined for an SRS set with the set usage configured as “codebook” or “non-codebook” associated with the PUSCH transmission; 2) the PLRS determined for a PUCCH resource having a predetermined identification (e.g., lowest identification); 3) the PLRS determined based on a QCL assumption or TCI state of a CORESET with a predetermined index (e.g., lowest index); 4) the PLRS determined based on an active TCI state with a predetermined identification (e.g., lowest identification); 5) the PLRS determined based on the indicated TCI state for the PUSCH; or 6) the PLRS indicated in a dedicated signaling for the PUSCH. In some aspects, the UE 110 may prioritize the default PLRS based on any predetermined order of the above multiple PLRSs. In one example, the UE 110 may prioritize the PLRS in 5) to the PLRS in 3) or the PLRS in 4). In another example, the UE110 may prioritize the PLRS in 1) or the PLRS in 2) to the PLRS in 5). In a further example, the UE110 may prioritize the PLRS in 6) to all the other PLRSs.

In another example, for joint DL/UL TCI configurations or UL TCI configurations applicable to an SRS transmission, the PLRS determining component 142, the modem 140, the processor 212, and/or the memory 216 of the UE 110 UE 110 may determine the PLRS for the SRS transmission as one PLRS from the following: 1) the PLRS determined for an SRS set with the set usage as “codebook” or “non-codebook” associated with the SRS transmission; 2) the PLRS determined for a PUCCH resource having a predetermined identification (e.g., lowest identification); 3) the PLRS determined based on a QCL assumption or TCI state of a CORESET with a predetermined index (e.g., lowest index); 4) the PLRS determined based on an active unified TCI state with a predetermined identification (e.g., lowest identification); 5) the PLRS determined based on the indicated TCI state for the SRS transmission; or 6) the PLRS indicated in a dedicated signaling for the SRS or a SRS set including the SRS.

In some aspects, the UE110 may prioritize the default PLRS based on any predetermined order of the above multiple PLRSs. In one example, the UE 110 may prioritize the PLRS in 5) to the PLRS in 3) or the PLRS in 4). In another example, the UE 110 may prioritize the PLRS in 1) or the PLRS in 2) to the PLRS in 5). In a further example, the UE110 may prioritize the PLRS in 6) to all the other PLRSs.

In another example, for joint DL/UL TCI configurations or UL TCI configuration applicable to an PUCCH transmission, the PLRS determining component 142, the modem 140, the processor 212, and/or the memory 216 of the UE 110 may determine the PLRS for the transmission of a PUCCH resource as one PLRS from the following: 1) the PLRS determined for a PUCCH resource having a predetermined identification (e.g., lowest identification); 2) the PLRS determined based on a QCL assumption or TCI state of a CORESET with a predetermined index (e.g., lowest index); 3) the PLRS determined based on an active TCI state with a predetermined identification (e.g., lowest identification); 4) the PLRS determined based on the indicated TCI state for the PUCCH; 5) the PLRS determined based on the indicated TCI state for a PUCCH resource group which includes the PUCCH resource for transmission; or 6) the PLRS indicated in a dedicated signaling for the PUCCH resource or a PUCCH resource group including the PUCCH resource.

In some aspects, the UE 110 may prioritize the default PLRS based on any predetermined order of the above multiple PLRSs. In one example, the UE 110 may prioritize the PLRS in 4) to the PLRS in 2) or the PLRS in 3). In another example, the UE110 may prioritize the PLRS in 1) or the PLRS in 5) to the PLRS in 4). In a further example, the UE110 may prioritize the PLRS in 6) to all the other PLRSs.

In an aspect, the PLRS determining component 142, the modem 140, the processor 212, and/or the memory 216 of the UE 110 may determine the pathloss and/or power control information based on the default PLRS. For example, the PLRS determining component 142, the modem 140, the processor 212, and/or the memory 216 of the UE 110 may calculate the pathloss and/or power control information based on a difference between the transmit power of the default PLRS and an RSRP measurement.

At block 508, the method 500 may include transmitting, to the base station, UL power control information based on the default PLRS in a UL transmission applicable to the TCI configuration. For example, the PLRS determining component 142, the modem 140, the transceiver 202, the processor 212, and/or the memory 216 of the UE 110, and/or one or more additional components/subcomponents of the UE 110 may be configured to or may comprise means for transmitting, to the base station, UL power control information based on the default PLRS in a UL transmission.

For example, the transmitting of the UL power control information at block 508 may include transmitting by the PLRS determining component 142, the modem 140, the transceiver 202, the processor 212, and/or the memory 216 of the UE 110, via the antenna 265, the RF front end 288, and/or the transceiver 202, to the UE 110, to the base station, UL power control information as illustrated by operation 406 of FIG. 4 based on the default PLRS. In an example, the UL transmission may be an SRS, PUCCH, or a PUSCH.

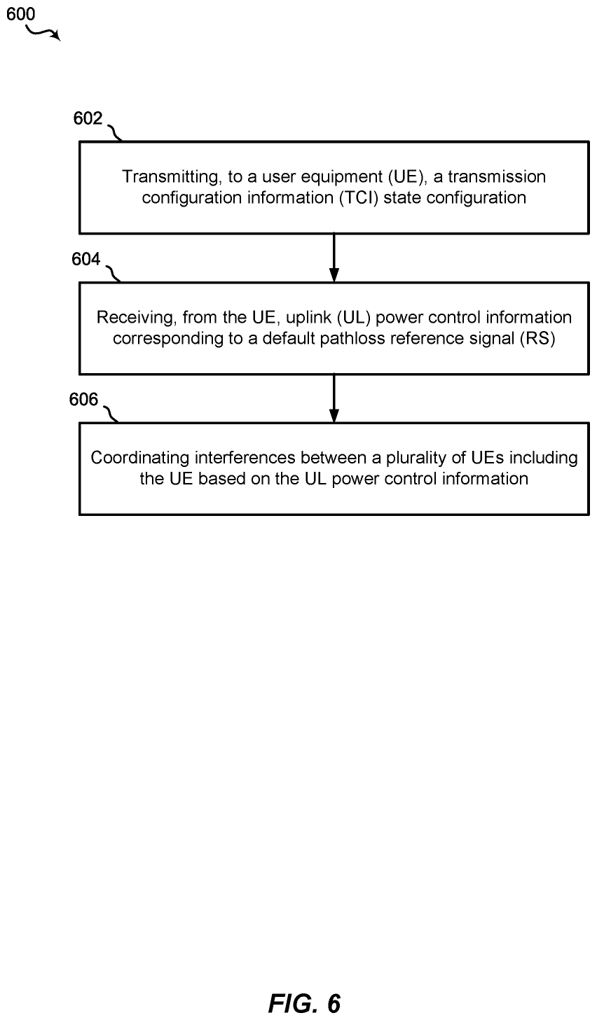

Referring to FIG. 6, an example of a method 600 for configuring PLRSs may be performed by the PLRS component 146, the modem 144, the transceiver 302, the processor 312, the memory 316, and or any other component/subcomponent of the base station 105 of the wireless communication network 100.

At block 602, the method 600 may include transmitting, to a UE, a TCI state configuration. For example, the PLRS component 146, the modem 144, the transceiver 302, the processor 312, and/or the memory 316 of the base station 105, and/or one or more additional components/subcomponents of the base station 105 may be configured to or may comprise means for transmitting, to a UE, a TCI state configuration.

For example, the transmitting of the TCI state configuration at the block 602 may include transmitting by the PLRS component 146, the modem 144, the transceiver 302, the processor 312, and/or the memory 316 of the base station 105, via the antenna 365, the RF front end 388, and/or the transceiver 202, to the UE 110, the TCI state configuration illustrated by operation 402 of FIG. 4. In an example, the TCI state configuration includes QCL information such as QCL type D RS.

At block 604, the method 800 may include receiving, from the UE, UL power control information corresponding to a default PLRS. For example, the PLRS component 146, the modem 144, the transceiver 302, the processor 312, and/or the memory 316 of the base station 105, and/or one or more additional components/subcomponents of the base station 105 may be configured to or may comprise means for receiving, from the UE, UL power control information corresponding to a default PLRS.

For example, the receiving of the UL power control information at the block 604 may include receiving by the PLRS component 146, the modem 144, the transceiver 302, the processor 312, and/or the memory 316 of the base station 105, via the antenna 365, the RF front end 388, and/or the transceiver 202, from the UE 110, UL power control information corresponding to a default PLRS as illustrated by operation 406 of FIG. 4.

At block 606, the method 600 may include coordinating interferences between a plurality of UEs including the UE based on the UL power control information. For example, the PLRS component 146, the modem 144, the transceiver 302, the processor 312, and/or the memory 316 of the base station 105, and/or one or more additional components/subcomponents of the base station 105 may be configured to or may comprise means for coordinating interferences between a plurality of UEs including the UE based on the UL power control information.

For example, the coordinating of the interferences at the block 606 may include coordinating by the PLRS component 146, the modem 144, the transceiver 302, the processor 312, and/or the memory 316 of the base station 105, communications between the UEs 110 to avoid inferences based on the UL power control information.

### Additional Implementations

An example method of wireless communication by a user equipment (UE), comprising: receiving, from a base station, a transmission configuration information (TCI) state configuration for a uplink (UL) transmission; determining a pathloss reference signal (PLRS) is not explicitly indicated by the TCI state configuration; obtaining a default PLRS in response to the PLRS not being explicitly indicated by the TCI state configuration; and transmitting, to the base station, the UL transmission with UL power control information based on the default PLRS.

The above example method, wherein obtaining the default PLRS comprises: setting a periodic downlink (DL) reference signal (RS) associated with a source RS as the default PLRS.

One or more of the above example methods, wherein obtaining the default PLRS comprises: setting a periodic channel state information (CSI)— reference signal (RS) associated with a source RS as the default PLRS.

One or more of the above example methods, wherein obtaining the default PLRS comprises: setting a quasi co-location (QCL) reference signal (RS) or spatial transmit filter RS of the TCI state configuration as the default PLRS.

One or more of the above example methods, wherein setting the QCL RS or the spatial relation information RS as the default PLRS comprises: selecting an RS resource index having a periodic RS with QCL information or spatial transmit filter information in the TCI state configuration; and setting an RS associated with the RS resource index as the default PLRS.

One or more of the above example methods, wherein setting the QCL RS or the spatial relation information RS as the default PLRS comprises: selecting an RS resource index having a periodic channel state information (CSI)-RS index that is quasi co-located with the RS resource index; and setting an RS associated with the RS resource index as the default PLRS.

One or more of the above example methods, wherein obtaining the default PLRS comprises: setting a quasi co-location (QCL) reference signal (RS) of a control resource set (CORESET) as the default PLRS.

One or more of the above example methods, wherein setting the QCL RS of the CORESET as the default PLRS comprises: selecting an RS resource index having a periodic RS resource with QCL information having a CORESET with a predetermined index; and setting an RS associated with the RS resource index as the default PLRS.

One or more of the above example methods, wherein obtaining the default PLRS comprises: setting a quasi co-location (QCL) reference signal (RS) or spatial relation information RS of an active TCI state of the TCI state configuration as the default PLRS.

One or more of the above example methods, wherein setting the QCL RS or the spatial relation information RS as the default PLRS comprises: selecting an RS resource index having a periodic RS with QCL information or spatial relation information in the active TCI state; and setting an RS associated with the RS resource index as the default PLRS.

One or more of the above example methods, wherein setting the QCL RS or the spatial relation information RS as the default PLRS comprises: selecting an RS resource index associated with the active TCI state and having a periodic channel state information (CSI)-RS index that is quasi co-located with the RS resource index; and setting an RS associated with the RS resource index as the default PLRS.

One or more of the above example methods, wherein the default PLRS is obtained in response to one or more of: a total number of active TCI states is less than or equal to a predetermined number of PLRSs; a total number of periodic quasi co-location (QCL) reference signals (RSs) in the active TCI states is greater than or equal to the predetermined number of PLRSs; a total number of periodic RSs serving as a QCL source for QCL RSs in the active TCI states is greater than or equal to the predetermined number of PLRSs; the base station indicates an application of the default PLRS via an enablement flag; or at least one PLRS of a plurality of PLRSs including the PLRS is explicitly configured in the TCI state configuration or configured outside the TCI state configuration and linked to the TCI state configuration.

One or more of the above example methods, wherein the predetermined number of PLRSs is four.

One or more of the above example methods, wherein the UL transmission is a physical UL share channel (PUSCH), and wherein the method further comprises: prioritizing the PLRS based on: the PLRS being associated with a sounding reference signal (SRS) set of a codebook or a non-codebook; the PLRS being associated with a physical UL control channel (PUCCH) having a predetermined identification; the PLRS being associated with a quasi co-located assumption of a control resource set (CORESET) with a predetermined index; the PLRS being associated with an active unified TCI state with a second predetermined identification; or the PLRS being associated with an indicated unified TCI state.

One or more of the above example methods, wherein the UL transmission is a sounding RS, and wherein the method further comprises: prioritizing the PLRS based on: the PLRS being associated with a quasi co-located assumption of a control resource set (CORESET) with a predetermined index; the PLRS being associated with an active unified TCI state with a predetermined identification; or the PLRS being associated with an indicated unified TCI state.

One or more of the above example methods, wherein the UL transmission is a physical UL control channel (PUCCH), and wherein the method further comprises: prioritizing the PLRS based on: the PLRS being associated with a quasi co-located assumption of a control resource set (CORESET) with a predetermined index; the PLRS being associated with an active unified TCI state with a predetermined identification; or the PLRS being associated with an indicated unified TCI state.

An apparatus, comprising: a memory comprising instructions; and one or more processors communicatively coupled with the memory and configured to perform any of the one or more above example methods.

A computer readable medium having instructions stored therein that, when executed by one or more processors, cause the one or more processors to perform any of the one or more above example methods.

An apparatus, comprising: means for performing any of the one or more above example methods.

A second example method of wireless communication by a base station, comprising: transmitting, to a user equipment (UE), a transmission configuration information (TCI) state configuration; receiving, from the UE, uplink (UL) power control information corresponding to a default pathloss reference signal (PLRS); and coordinating interferences between a plurality of UEs including the UE based on the UL power control information.

An apparatus, comprising: a memory comprising instructions; and one or more processors communicatively coupled with the memory and configured to perform any of the one or more above second example methods.

A computer readable medium having instructions stored therein that, when executed by one or more processors, cause the one or more processors to perform any of the one or more above second example methods.

An apparatus, comprising: means for performing any of the one or more above second example methods.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method of wireless communication by a user equipment (UE), comprising:
receiving, from a base station, a transmission configuration information (TCI) state configuration for a uplink (UL) transmission;
determining a pathloss reference signal (PLRS) is not explicitly indicated by the TCI state configuration;
obtaining a default PLRS in response to the PLRS not being explicitly indicated by the TCI state configuration; and
transmitting, to the base station, the UL transmission with UL power control information based on the default PLRS.

2. The method of claim 1, wherein obtaining the default PLRS comprises:
setting a periodic downlink (DL) reference signal (RS) associated with a source RS as the default PLRS.

3. The method of claim 1, wherein obtaining the default PLRS comprises:
setting a periodic channel state information (CSI)— reference signal (RS) associated with a source RS as the default PLRS.

4. The method of claim 1, wherein obtaining the default PLRS comprises:
setting a quasi co-location (QCL) reference signal (RS) or spatial transmit filter RS of the TCI state configuration as the default PLRS.

5. The method of claim 4, wherein setting the QCL RS or the spatial transmit filter RS as the default PLRS comprises:
selecting an RS resource index having a periodic RS with QCL information or spatial transmit filter information in the TCI state configuration; and
setting an RS associated with the RS resource index as the default PLRS.

6. The method of claim 4, wherein setting the QCL RS or the spatial transmit filter RS as the default PLRS comprises:
selecting an RS resource index having a periodic channel state information (CSI)-RS index that is quasi co-located with the RS resource index; and
setting an RS associated with the RS resource index as the default PLRS.

7. The method of claim 1, wherein obtaining the default PLRS comprises:
setting a quasi co-location (QCL) reference signal (RS) of a control resource set (CORESET) as the default PLRS.

8. The method of claim 7, wherein setting the QCL RS of the CORESET as the default PLRS comprises:
selecting an RS resource index having a periodic RS resource with QCL information having a CORESET with a predetermined index; and
setting an RS associated with the RS resource index as the default PLRS.

9. The method of claim 1, wherein obtaining the default PLRS comprises:
setting a quasi co-location (QCL) reference signal (RS) or spatial relation information RS of an active TCI state of the TCI state configuration as the default PLRS.

10. The method of claim 9, wherein setting the QCL RS or the spatial relation information RS as the default PLRS comprises:
selecting an RS resource index having a periodic RS with QCL information or spatial relation information in the active TCI state; and
setting an RS associated with the RS resource index as the default PLRS.

11. The method of claim 9, wherein setting the QCL RS or the spatial relation information RS as the default PLRS comprises:
selecting an RS resource index associated with the active TCI state and having a periodic channel state information (CSI)-RS index that is quasi co-located with the RS resource index; and
setting an RS associated with the RS resource index as the default PLRS.

12. The method of claim 1, wherein the default PLRS is obtained in response to one or more of:
a total number of active TCI states is less than or equal to a predetermined number of PLRSs;
a total number of periodic quasi co-location (QCL) reference signals (RSs) in the active TCI states is greater than or equal to the predetermined number of PLRSs;
a total number of periodic RSs serving as a QCL source for QCL RSs in the active TCI states is greater than or equal to the predetermined number of PLRSs;
the base station indicates an application of the default PLRS via an enablement flag; or
at least one PLRS of a plurality of PLRSs including the PLRS is explicitly configured in the TCI state configuration or configured outside the TCI state configuration and linked to the TCI state configuration.

13. The method of claim 12, wherein the predetermined number of PLRSs is four.

14. The method of claim 1,
wherein the UL transmission is a physical UL share channel (PUSCH), and wherein the method further comprises:
prioritizing the PLRS based on:
the PLRS being associated with a sounding reference signal (SRS) set of a codebook or a non-codebook;
the PLRS being associated with a physical UL control channel (PUCCH) having a predetermined identification;
the PLRS being associated with a quasi co-located assumption of a control resource set (CORESET) with a predetermined index;
the PLRS being associated with an active unified TCI state with a second predetermined identification; or
the PLRS being associated with an indicated unified TCI state;
wherein the UL transmission is a sounding RS, and wherein the method further comprises:
prioritizing the PLRS based on:
the PLRS being associated with a quasi co-located assumption of a control resource set (CORESET) with a predetermined index;
the PLRS being associated with an active unified TCI state with a predetermined identification; or
the PLRS being associated with an indicated unified TCI state; and
wherein the UL transmission is a physical UL control channel (PUCCH), and wherein the method further comprises:
prioritizing the PLRS based on:
the PLRS being associated with a quasi co-located assumption of a control resource set (CORESET) with a predetermined index;
the PLRS being associated with an active unified TCI state with a predetermined identification: or
the PLRS being associated with an indicated unified TCI state.

15-20. (canceled)

21. An apparatus for wireless communications, comprising:
at least one processor; and
memory coupled with the at least one processor, the memory including instructions executable by the at least one processor, individually or in any combination, to cause the apparatus to:
receive, from a base station, a transmission configuration information (TCI) state configuration for a uplink (UL) transmission;
determine a pathloss reference signal (PLRS) is not explicitly indicated by the TCI state configuration;
obtain a default PLRS in response to the PLRS not being explicitly indicated by the TCI state configuration; and
transmit, to the base station, the UL transmission with UL power control information based on the default PLRS.

22. The apparatus of claim 21, wherein the obtain the default PLRS comprises:
setting a periodic downlink (DL) reference signal (RS) associated with a source RS as the default PLRS.

23. The apparatus of claim 21, wherein the obtain the default PLRS comprises:
setting a periodic channel state information (CSI)— reference signal (RS) associated with a source RS as the default PLRS.

24. The apparatus of claim 21, wherein the default PLRS comprises:
setting a quasi co-location (QCL) reference signal (RS) or spatial transmit filter RS of the TCI state configuration as the default PLRS.

25. The apparatus of claim 24, wherein the setting the QCL RS or the spatial transmit filter RS as the default PLRS comprises:
selecting an RS resource index having a periodic RS with QCL information or spatial transmit filter information in the TCI state configuration; and
setting an RS associated with the RS resource index as the default PLRS.

26. The apparatus of claim 24, wherein the setting the QCL RS or the spatial transmit filter RS as the default PLRS comprises:
selecting an RS resource index having a periodic channel state information (CSI)-RS index that is quasi co-located with the RS resource index; and
setting an RS associated with the RS resource index as the default PLRS.

27. The apparatus of claim 21, wherein the obtain the default PLRS comprises:
setting a quasi co-location (QCL) reference signal (RS) of a control resource set (CORESET) as the default PLRS.

28. The apparatus of claim 27, wherein the setting the QCL RS of the CORESET as the default PLRS comprises:
selecting an RS resource index having a periodic RS resource with QCL information having a CORESET with a predetermined index; and
setting an RS associated with the RS resource index as the default PLRS.

29. The apparatus of claim 21, wherein the obtain the default PLRS comprises:
setting a quasi co-location (QCL) reference signal (RS) or spatial relation information RS of an active TCI state of the TCI state configuration as the default PLRS.

30. The apparatus of claim 29, wherein the QCL RS or the spatial relation information RS as the default PLRS comprises:
selecting an RS resource index having a periodic RS with QCL information or spatial relation information in the active TCI state; and
setting an RS associated with the RS resource index as the default PLRS.

31. The apparatus of claim 29, wherein the setting the QCL RS or the spatial relation information RS as the default PLRS comprises:
selecting an RS resource index associated with the active TCI state and having a periodic channel state information (CSI)-RS index that is quasi co-located with the RS resource index; and
setting an RS associated with the RS resource index as the default PLRS.

32. The apparatus of claim 21, wherein the default PLRS is obtained in response to one or more of:
a total number of active TCI states is less than or equal to a predetermined number of PLRSs;
a total number of periodic quasi co-location (QCL) reference signals (RSs) in the active TCI states is greater than or equal to the predetermined number of PLRSs;
a total number of periodic RSs serving as a QCL source for QCL RSs in the active TCI states is greater than or equal to the predetermined number of PLRSs;
the base station indicates an application of the default PLRS via an enablement flag; or
at least one PLRS of a plurality of PLRSs including the PLRS is explicitly configured in the TCI state configuration or configured outside the TCI state configuration and linked to the TCI state configuration.

33. The apparatus of claim 32, wherein the predetermined number of PLRSs is four.

34. The apparatus of claim 21,
wherein the UL transmission is a physical UL share channel (PUSCH), and wherein the instructions executable by the at least one processor, individually or in combination, to further cause the apparatus to:
prioritizing the PLRS based on:
the PLRS being associated with a sounding reference signal (SRS) set of a codebook or a non-codebook;
the PLRS being associated with a physical UL control channel (PUCCH) having a predetermined identification;
the PLRS being associated with a quasi co-located assumption of a control resource set (CORESET) with a predetermined index;
the PLRS being associated with an active unified TCI state with a second predetermined identification; or
the PLRS being associated with an indicated unified TCI state;
wherein the UL transmission is a sounding RS, and wherein the instructions executable by the at least one processor, individually or in combination, to further cause the apparatus to:
prioritizing the PLRS based on:
the PLRS being associated with a quasi co-located assumption of a control resource set (CORESET) with a predetermined index;
the PLRS being associated with an active unified TCI state with a predetermined identification; or
the PLRS being associated with an indicated unified TCI state; and
wherein the UL transmission is a physical UL control channel (PUCCH), and wherein the instructions executable by the at least one processor, individually or in combination, to further cause the apparatus to:
prioritizing the PLRS based on:
the PLRS being associated with a quasi co-located assumption of a control resource set (CORESET) with a predetermined index;
the PLRS being associated with an active unified TCI state with a predetermined identification; or
the PLRS being associated with an indicated unified TCI state.

35. A computer readable medium having instructions stored therein that, when executed by one or more processors, cause the one or more processors, either individually or in any combination, to:
receive, from a base station, a transmission configuration information (TCI) state configuration for a uplink (UL) transmission;
determine a pathloss reference signal (PLRS) is not explicitly indicated by the TCI state configuration;
obtain a default PLRS in response to the PLRS not being explicitly indicated by the TCI state configuration; and
transmit, to the base station, the UL transmission with UL power control information based on the default PLRS.

36. An apparatus for wireless communications, comprising:
means for receiving, from a base station, a transmission configuration information (TCI) state configuration for a uplink (UL) transmission;
means for determining a pathloss reference signal (PLRS) is not explicitly indicated by the TCI state configuration;
means for obtaining a default PLRS in response to the PLRS not being explicitly indicated by the TCI state configuration; and
means for transmitting, to the base station, the UL transmission with UL power control information based on the default PLRS.
